(19) United States
(12) Patent Application Publication
(10) Pub. No.: US 2026/0336101 A1
(43) Pub. Date: Oct. 29, 2026

(54) ACTIVE DISTURBANCE REJECTION CONTROL METHOD FOR LINEAR ELECTRIC-DRIVEN JOINT OF HUMANOID ROBOT

(71) Applicant: HANGZHOU SEENPIN ELECTROMECHANICAL TRANSMISSION CO., LTD., Hangzhou (CN)

(72) Inventors: Xinping SHAN, Hangzhou (CN); Zuohai YAN, Hangzhou (CN)

(21) Appl. No.: 19/453,739

(22) Filed: Jan. 20, 2026

Related U.S. Application Data
(63) Continuation of application No. PCT/CN2025/139535, filed on Dec. 3, 2025.

(30) Foreign Application Priority Data
Apr. 27, 2025 (CN) 202510536110.8

(51) Int. Cl. B25J 9/16; B25J 17/00; B62D 57/032

(52) U.S. Cl. CPC B25J 9/163; B25J 9/1653; B25J 17/00; B62D 57/032

(57) ABSTRACT

The present invention discloses an active disturbance rejection control method for a linear electric-driven joint of a humanoid robot, and the method includes: establishing a dynamic model for a linear electric-driven joint system used in the humanoid robot; determining an extended state observer based on the dynamic model, estimating a state variable and an unknown disturbance of the system in real time, and dynamically compensating for the disturbance through the extended state observer; determining a nonlinear feedback control law based on states and estimated disturbance information observed by the extended state observer; and analyzing stability of the extended state observer and the nonlinear feedback control law, and adjusting parameters of the extended state observer and the nonlinear feedback control law based on analysis results. For the active disturbance rejection control method for a linear electric-driven joint of a humanoid robot according to the present invention, an active disturbance rejection control technology is adopted to overcome limitations of conventional PID control in a nonlinear and uncertain system, efficiently controlling the linear electric-driven joint, thereby enhancing dynamic performance and robustness of the humanoid robot.

### CROSS-REFERENCE TO RELATED APPLICATIONS

This application is a Continuation of PCT International Application No. PCT/CN2025/139535 filed on Dec. 3, 2025, which claims the benefit of Chinese Patent Application No. CN 202510536110.8, filed Apr. 27, 2025, the contents of each of which are incorporated herein by reference.

### FIELD OF TECHNOLOGY

The present invention belongs to the technical field of control for linear electric-driven joints of humanoid robots, and specifically relates to an active disturbance rejection control method for a linear electric-driven joint of a humanoid robot.

### BACKGROUND

With the continuous development of robotics technology, humanoid robots are being increasingly applied in fields such as intelligent manufacturing, household services, and smart medical care. In order to achieve high-precision and high-stability motion control for the humanoid robots, it is particularly important to research efficient joint control methods. Conventional PID control methods often fail to achieve ideal results when dealing with complex nonlinear systems and external disturbances. Active disturbance rejection control (ADRC), as a novel control method, features strong robustness and excellent dynamic performance, and can effectively suppress uncertainties and external disturbances in the system.

### SUMMARY

The present invention provides an active disturbance rejection control method for a linear electric-driven joint of a humanoid robot to address the above-mentioned technical problems, and specifically the following technical solution is adopted:

An active disturbance rejection control method for a linear electric-driven joint of a humanoid robot is provided, and includes:
S1: establishing a dynamic model for a linear electric-driven joint system used in the humanoid robot;
S2: determining an extended state observer based on the dynamic model, estimating a state variable and an unknown disturbance of the system in real time, and dynamically compensating for the disturbance through the extended state observer;
S3: determining a nonlinear feedback control law based on states and estimated disturbance information observed by the extended state observer; and
S4: analyzing stability of the extended state observer and the nonlinear feedback control law, and adjusting parameters of the extended state observer and the nonlinear feedback control law based on analysis results.

Further, in Step S1, the dynamic model for a linear electric-driven joint system used in the humanoid robot is:

M\ddot{q}+B\dot{q}+Kq=F
where M is an equivalent mass of a driver, B is a damping coefficient, K is a stiffness coefficient, q is a joint position, and F is a control input.

Further, in Step S1, the dynamic model is also converted to obtain a state-space model of the system.

Further, in Step S1, a method for converting the dynamic model to obtain the state-space model of the system specifically includes:
defining the state variable:

x₁=q, x₂=\dot{q}
where a state vector is

$$x = [ \begin{matrix}{x}_{1} \\ {x}_{2}\end{matrix} ] = [ \begin{matrix}q \\ \dot{q}\end{matrix} ] ,$$

the dynamic model is converted into a state-space form:

\dot{x}₁=x₂,

$${\dot{x}}_{2} = \frac{F - B {x}_{2} - K {x}_{1}}{M} ;$$

and finally a state-space model of the dynamic model of the system is obtained and has a state equation as follows:

$$\dot{x} = [ \begin{matrix}0 & 1 \\ - \frac{K}{M} & - \frac{B}{M}\end{matrix} ] x + [ \begin{matrix}0 \\ \frac{1}{M}\end{matrix} ] F .$$

Further, in Step S2, the system is affected by the unknown disturbance d(t), the unknown disturbance d(t) is regarded as a total disturbance and estimated by the extended state observer, and the total disturbance d(t) is:

$$d ( t ) = - \frac{K}{M} {x}_{1} - \frac{B}{M} {x}_{2}$$

the total disturbance d(t) and a system state are jointly estimated by extending a new state variable z, and the extended state observer is:

\dot{\hat{x}}₁=\hat{x}₂−β₁(y−\hat{x}₁);

$${\dot{\hat{x}}}_{2} = \frac{F}{M} + \hat{z} - {β}_{2} ( y - {\hat{x}}_{1} ) ;$$

\dot{\hat{z}}=−β₃(y−\hat{x}₁);
where \hat{x} is an estimated system state, \hat{z} is an estimated total disturbance, y=x₁ is a system output, and β₁, β₂, and β₃ are gain parameters of the extended state observer.

Further, in Step S3, a nonlinear error feedback control law is used to generate the control input F, so that the system achieves a desired output; and the nonlinear error feedback control law is:

F=M(v−\hat{z})
where v is a virtual control variable used to generate a desired dynamic behavior:

v=−k₁(q−q_{ref})−k₂\dot{q}
where q_{ref} is a desired joint position, and k₁ and k₂ are control gain parameters.

Further, in Step S4, a Lyapunov function V(e) is constructed to analyze the stability of the extended state observer:

$$V ( e ) = \frac{1}{2} ( {e}_{1}^{2} + {e}_{2}^{2} + {e}_{z}^{2} )$$

a derivative of the Lyapunov function V(e) is taken as follows:

\dot{V}(e)=e₁ė₁+e₂ė²+e_{z}ė_{z}
based on the formula of the extended state observer in Step S2, an error equation is obtained; an error dynamic equation is substituted into the above formula to obtain:

$$\dot{V} ( e ) = - {β}_{1} {e}_{1}^{2} - \frac{B}{M} {e}_{2}^{2} + ( {β}_{2} - \frac{K}{M} ) {e}_{1} {e}_{2} - {β}_{3} {e}_{z}^{2}$$

and the parameters β₁, β₂, and β₃ are selected to enable \dot{V}(e)<0 to ensure asymptotic stability of the system.

Further, in Step S4, the nonlinear error feedback control law is analyzed, and is substituted into a system equation to obtain a closed-loop system:

\dot{x}₁=x₂;

\dot{x}₂=−k₁(x₁−q_{ref})−k₂x₂+d(t)−\hat{z};

A closed-loop system without disturbance is considered as:

$$[ \begin{matrix}{\dot{x}}_{1} \\ {\dot{x}}_{2}\end{matrix} ] [ \begin{matrix}0 & 1 \\ - {k}_{1} & - {k}_{1}\end{matrix} ] [ \begin{matrix}{x}_{1} \\ {x}_{2}\end{matrix} ]$$

a characteristic equation is:

λ²+k₂λ+k₁=0
and k₁ and k₂ are selected to ensure that an eigenvalue has a negative real part, thereby ensuring system stability.

Further, value ranges of k₁ and k₂ are: k₁>0, k₂>0, and

$${k}_{2}^{2} - 4 {k}_{1} < 0 .$$

The advantage of the present invention is that for the active disturbance rejection control method for a linear electric-driven joint of a humanoid robot according to the present invention, an active disturbance rejection control technology is adopted to overcome limitations of conventional PID control in a nonlinear and uncertain system, efficiently controlling the linear electric-driven joint, thereby enhancing dynamic performance and robustness of the humanoid robot.

The advantage of the present invention is that the active disturbance rejection control method for a linear electric-driven joint of a humanoid robot according to the present invention, as verified, demonstrates superiority in suppressing external disturbances and uncertainties, ensuring that robot joints maintain stable motion performance under various working conditions.

### BRIEF DESCRIPTION OF THE DRAWINGS

In order to more clearly explain embodiments of the present invention or the technical solution in the prior art, the accompanying drawings needed in the descriptions of the embodiments or the prior art will be briefly introduced below. Apparently, the accompanying drawings in the following descriptions are only some embodiments of the present invention. Other accompanying drawings also may be obtained by ordinary persons skilled in the art based on these drawings without any creative labor.

FIG. 1 shows a flowchart of an active disturbance rejection control method for a linear electric-driven joint of a humanoid robot according to the present invention;

FIG. 2 shows a plot of step response control results of an active disturbance rejection control method for a linear electric-driven joint of a humanoid robot according to the present invention;

FIG. 3 shows a plot of step response control input of an active disturbance rejection control method for a linear electric-driven joint of a humanoid robot according to the present invention;

FIG. 4 shows a plot of constant disturbance applied in step response control of an active disturbance rejection control method for a linear electric-driven joint of a humanoid robot according to the present invention;

FIG. 5 shows a plot of sinusoidal response control results of an active disturbance rejection control method for a linear electric-driven joint of a humanoid robot according to the present invention;

FIG. 6 shows a plot of sinusoidal response control input of an active disturbance rejection control method for a linear electric-driven joint of a humanoid robot according to the present invention; and

FIG. 7 shows a plot of constant disturbance applied in sinusoidal response control of an active disturbance rejection control method for a linear electric-driven joint of a humanoid robot according to the present invention.

### DESCRIPTION OF THE EMBODIMENTS

Embodiments of the present invention are described in detail below. Examples of the embodiments are shown in the accompanying drawings, and same or similar reference numerals indicate same or similar elements or elements with same or similar functions throughout the drawings. The embodiments described below with reference to the accompanying drawings are exemplary and are intended to explain the present invention, and should not be construed as a limitation to the present invention.

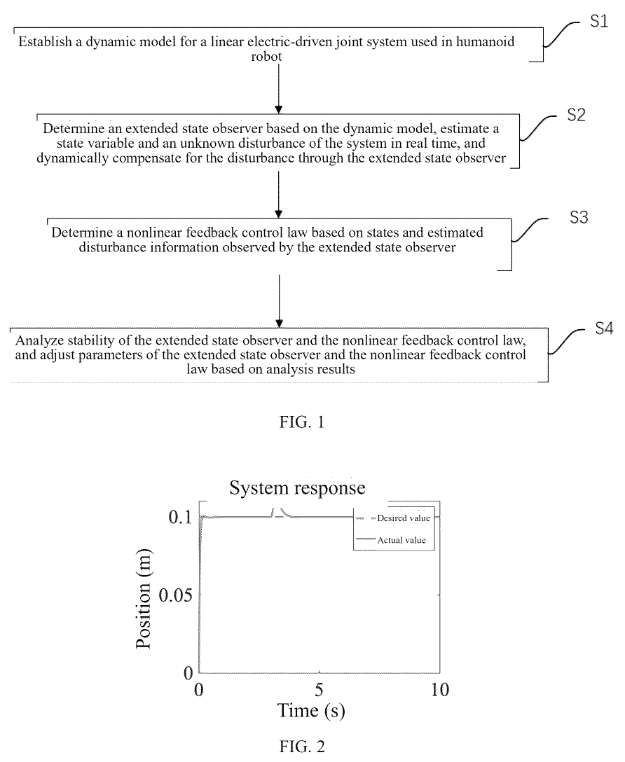

As shown in FIG. 1, the present application provides an active disturbance rejection control method for a linear electric-driven joint of a humanoid robot, and includes:
Step S1: establish a dynamic model for a linear electric-driven joint system used in the humanoid robot.

In an embodiment of the present application, the dynamic model for a linear electric-driven joint system used in the humanoid robot is:

M\ddot{q}+B\dot{q}+Kq=F
where M is an equivalent mass of a driver, B is a damping coefficient, K is a stiffness coefficient, q is a joint position, and F is an applied force or a control input.

In an embodiment of the present application, in order to facilitate controller design, the dynamic model is also converted to obtain a state-space model of the system.

A method for converting the dynamic model to obtain the state-space model of the system specifically includes:

defining the state variable:

x₁=q, x₂=\dot{q}
where a state vector is

$$x = [ \begin{matrix}{x}_{1} \\ {x}_{2}\end{matrix} ] = [ \begin{matrix}q \\ \dot{q}\end{matrix} ] ,$$

the dynamic model is converted into a state-space form:

\dot{x}₁=x₂,

$${\dot{x}}_{2} = \frac{F - B {x}_{2} - K {x}_{1}}{M}$$

and finally a state-space model of the dynamic model of the system is obtained and has a state equation as follows:

$$\dot{x} = [ \begin{matrix}0 & 1 \\ - \frac{K}{M} & - \frac{B}{M}\end{matrix} ] x + [ \begin{matrix}0 \\ \frac{1}{M}\end{matrix} ] F .$$

Step S2: determine an extended state observer based on the dynamic model, estimate a state variable and an unknown disturbance of the system in real time, and dynamically compensate for the disturbance through the extended state observer.

A purpose of the extended state observer is to estimate a system state and a total disturbance. In active disturbance rejection control, it is assumed that the system is affected by the unknown disturbance d(t), and the unknown disturbance is regarded as the total disturbance and estimated by the extended state observer. It is assumed that the total disturbance d(t) is:

$$d ( t ) = - \frac{K}{M} {x}_{1} - \frac{B}{M} {x}_{2}$$

the total disturbance d(t) and a system state are jointly estimated by extending a new state variable z, and the extended state observer is:

\dot{\hat{x}}₁=\hat{x}₂−β₁(y−\hat{x}₁);

$${\dot{\hat{x}}}_{2} = \frac{F}{M} + \hat{z} - {β}_{2} ( y - {\hat{x}}_{1} ) ;$$

\dot{\hat{z}}=−β₃(y−\hat{x}₁);
where \hat{x} is an estimated system state, \dot{\hat{z}} is an estimated total disturbance, y=x₁ is a system output, β₁, β₂, and β₃ are gain parameters of the extended state observer and are adjusted to control the response speed and accuracy of the observer.
Step S3: determine a nonlinear feedback control law based on states and estimated disturbance information observed by the extended state observer.

In an embodiment of the present application, a nonlinear error feedback control law is used to generate the control input F, so that the system achieves a desired output. In active disturbance rejection control, the nonlinear error feedback control law is:

F=M(v−\hat{z})
where vis a virtual control variable used to generate a desired dynamic behavior:

v=−k₁(q−q_{ref})−k₂\dot{q}
where q_{ref} is a desired joint position, and k₁ and k₂ are control gain parameters.

Design of v ensures that system response satisfies expectations, and the response speed and stability can be controlled by k₁ and k₂. The control input F includes feedback of disturbance estimate 2, which can dynamically compensate for the disturbance and improve control performance.
Step S4: analyze stability of the extended state observer and the nonlinear feedback control law, and adjust parameters of the extended state observer and the nonlinear feedback control law based on analysis results to obtain a final controller.

In an embodiment of the present application, a Lyapunov function V(e) is constructed to analyze the stability of the extended state observer:

$$V ( e ) = \frac{1}{2} ( {e}_{1}^{2} + {e}_{2}^{2} + {e}_{z}^{2} )$$

a derivative of the Lyapunov function V(e) is taken as follows:

\dot{V}(e)=e₁ė₁+e₂ė₂+e_{z}ė_{z}
based on the formula of the extended state observer in Step S2, an error equation is obtained; an error dynamic equation is substituted into the above formula to obtain:

$$\dot{V} ( e ) = - {β}_{1} {e}_{1}^{2} - \frac{B}{M} {e}_{2}^{2} + ( {β}_{2} - \frac{K}{M} ) {e}_{1} {e}_{2} - {β}_{3} {e}_{z}^{2}$$

and the parameters β₁, β₂, and β₃ are selected to enable \dot{V}(e)<0 to ensure asymptotic stability of the system.

Specifically, β₁>0. Preferably, a larger β₁ is selected, and increasing β₁ can ensure that

$$- {β}_{1} {e}_{1}^{2}$$

term makes a greater negative contribution to an overall derivative, thereby making it easier to satisfy \dot{V}(e)<0.

$${β}_{2} \approx \frac{K}{M} ,$$

to offset the influence of a cross term. Preferably,

$${β}_{2} = \frac{K}{M} .$$

β₃>0. Preferably, a larger β₃ is selected, and increasing β₃ can ensure that

$$- {β}_{3} {e}_{1}^{2}$$

term makes a greater negative contribution to an overall derivative, thereby making it easier to satisfy \dot{V}(e)<0.

These parameters are reasonably selected according to the above conditions, it can be ensured that the derivative of the Lyapunov function is always negative, thereby ensuring that the error dynamics of the system are asymptotically stable. In practical design, in addition to theoretical parameter selection, it is also necessary to verify the effectiveness of the parameters and the robustness of the system through simulation and experiments.

In an embodiment of the present application, the nonlinear error feedback control law is analyzed, and is substituted into a system equation to obtain a closed-loop system:

\dot{x}₁=x₂;

\dot{x}₂=−k₁(x₁−q_{ref})−k₂x₂+d(t)−\hat{z};
a closed-loop system without disturbance is considered as:

$$[ \begin{matrix}{\dot{x}}_{1} \\ {\dot{x}}_{2}\end{matrix} ] [ \begin{matrix}0 & 1 \\ - {k}_{1} & - {k}_{1}\end{matrix} ] [ \begin{matrix}{x}_{1} \\ {x}_{2}\end{matrix} ]$$

a characteristic equation is:

λ²+k₂λ+k₁=0
and k₁ and k₂ are selected to ensure that an eigenvalue has a negative real part, thereby ensuring system stability.

Specifically, appropriate k₁ and k₂ are selected to ensure that the eigenvalue has a negative real part, thereby ensuring system stability. To ensure system stability, the roots of the characteristic equation (namely, the eigenvalue) must have the negative real part. This can be achieved by the following conditions:

k₁>0, ensuring that the constant term of the characteristic equation is positive. This is one of the necessary conditions to ensure that the natural frequency of the system is positive.

k₂>0, ensuring that the coefficient of the linear term is positive. This helps to provide sufficient damping, enabling the system to converge rapidly.

A discriminant is less than 0. To ensure that the eigenvalue is a complex number and has the negative real part, the discriminant must satisfy:

$${k}_{2}^{2} - 4 {k}_{1} < 0$$

This means that the eigenvalue is a complex conjugate pair, and since k₂>0, the real part thereof is negative. k₁>0 and k₂>0: these conditions ensure that the system has a positive natural frequency and sufficient damping. It is ensured that the eigenvalue is in complex form, and due to the positive value of k₂, the real part of the eigenvalue is negative, meaning that the system response is stable and exhibits oscillatory characteristics.

These conditions are satisfied, so that the closed-loop dynamic behavior of the system remains stable under disturbances and uncertainties. Appropriate k₁ and k₂ are usually selected based on specific requirements and performance indicators of the system and debugged and verified through examples.

The following design example verifies the active disturbance rejection control method for a linear electric-driven joint of a humanoid robot proposed in the present invention. During the implementation of the present invention, the following three system performances are analyzed through experiments:
Tracking performance: check whether the system can track a set point q_{ref} quickly and without overshoot.
Disturbance rejection performance: different disturbances d(t) are applied to test the capability to suppress disturbances by the controller.
Steady-state error: verify whether there is any deviation in a steady state, ensuring the accuracy of the controller.

System parameters and parameter design of the controller in the present invention are shown in Table 1 below:

TABLE 1
Controller Parameters

Parameter Name

| | β₁ | β₂ | β₃ | k₁ | k₂ |
|---|---|---|---|---|---|
| Parameter | 30 | 300 | 1000 | 500 | 50 |
| Gain | | | | | |

To verify the performance of the controller, step response and sinusoidal response tests are designed to achieve position control, and disturbances are applied to verify the tracking and disturbance rejection performance of an active disturbance rejection control algorithm. To verify the performance of an active disturbance rejection controller, step response and sinusoidal response test methods are adopted. External disturbances are applied to evaluate the tracking and disturbance rejection performance of a control algorithm. Specific design and process are as follows.

### 1. Step Response Test

The step response test is an important method to verify the response speed and stability of a control system. Test objective: to verify the rapid response capability of the controller when facing abrupt input signals, and to examine the rise time, overshoot, and steady-state error of the system. Implementation: a target value of a joint position is suddenly changed (step change), for example, from an initial position of 0 to a fixed target position (such as 0.1 m), to observe whether the system can quickly and smoothly track a target. Disturbance application: in a step response process, disturbances (such as a constant disturbance force or a pulse disturbance force) are applied at the control input or output of the system to simulate possible environmental disturbances. The system response is observed to evaluate the recovery capability of the controller under the disturbances.

### 2. Sinusoidal Response Test

The sinusoidal response test is used to evaluate the dynamic tracking performance and phase response capability of the control system. Test objective: to verify the accuracy and phase delay of the controller when tracking periodic input signals (sinusoidal signals), and to examine response characteristics thereof under continuously varying reference signals. Implementation: a sinusoidal position input signal is given, for example, a sinusoidal signal with an amplitude of 0.1 m and a frequency of 0.5 Hz, and the tracking performance of the system over an entire period is observed.

Disturbance application: during sinusoidal tracking, different types of disturbances (such as random noise or periodic disturbances) are applied to observe the error change and recovery time of the control system disturbed. The step can test the disturbance rejection capability of the controller under continuous dynamic input.

The experimental results are shown in FIG. 2-FIG. 7, indicating that the controller performs excellently in both the step response test and the sinusoidal response test, as detailed below:

### 3. Analysis of Step Response Test Results

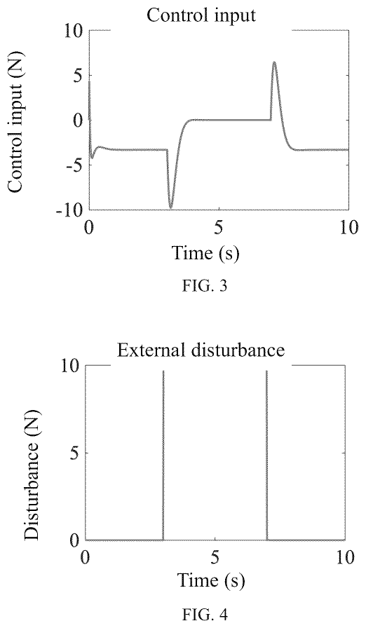

Step response results are shown in FIG. 2-FIG. 4, where FIG. 2 shows step response results, FIG. 3 shows corresponding control input, and FIG. 4 shows applied constant external disturbance.
Rise time: in a process where the target position jumps from 0 to 0.1 m, the system exhibits a short rise time, quickly reaching 90% of the target value. This indicates that the controller has a fast response capability and can promptly follow changes in the input signal.
Overshoot: as observed from FIG. 2, the system has a small overshoot in a rise process, with no significant overshoot phenomenon. This means that controller parameters are reasonably designed, effectively suppressing the unstable oscillations of the system, thereby avoiding significant fluctuations of the system when reaching the target position.
Steady-state error: as shown in FIG. 2, the system has minimal error after reaching a steady state, and the minimal error is accurately maintained near the target value of 0.1 m, with a steady-state error of about 0.01 mm. This demonstrates that the controller has good steady-state performance and can ensure that the system remains consistent with the target position in a final state.
Disturbance rejection capability: after a constant disturbance force is applied in the step response process (as shown in FIG. 4), the system exhibits strong disturbance rejection capability. Although there is a brief deviation under the effect of the disturbance, the system quickly returns to the target position. This indicates that the controller has strong recovery capability and robustness in the face of sudden disturbances.

Overall, the step response test results show that the controller has fast and stable response characteristics and can effectively resist external disturbances.

### 4. Analysis of Sinusoidal Response Test Results

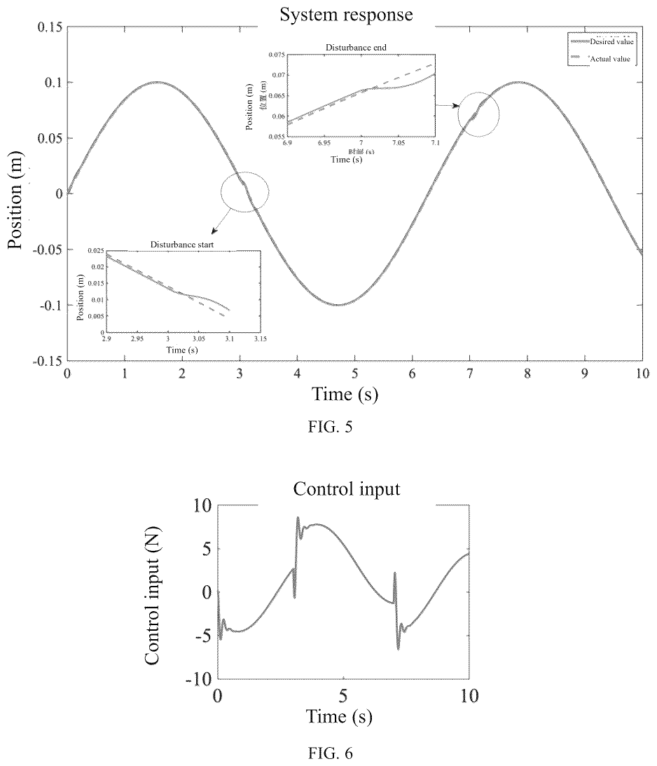

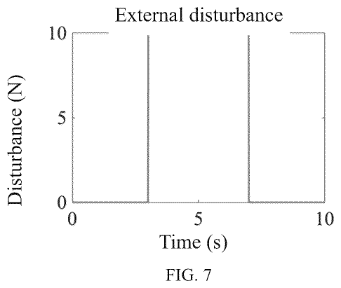

Sinusoidal response results are shown in FIG. 5-FIG. 7, where FIG. 5 shows sinusoidal response results, FIG. 6 shows corresponding control input, and FIG. 7 shows applied constant external disturbance.
Tracking accuracy: as shown in FIG. 5, in a process where a sinusoidal signal with a frequency of 0.5 Hz and an amplitude of 0.1 m is tracked, output signals of the system remain highly consistent with input signals thereof, and the system exhibits excellent tracking accuracy with an error of about 0.01 mm. An amplitude error within a sinusoidal period is minimal, indicating that the controller can accurately track periodic input signals.
Phase delay: as shown in FIG. 5, experimental results show that a phase difference between the output signals of the system and the input sinusoidal signal of the system is very small, indicating that the controller has good phase response capability and can remain synchronized with the input signals. The characteristic is particularly important for dynamic tracking tasks, indicating that the controller is suitable for applications that need to be frequently adjusted and rapidly respond.
Disturbance rejection performance: as shown in FIG. 5, during the sinusoidal tracking test, after random noise and periodic disturbances are added, the system quickly returns to normal after a brief deviation, showing strong disturbance rejection performance. The error variation under disturbance is small and the recovery time is short, indicating that the controller can effectively suppress disturbances under dynamic input.

To sum up, the sinusoidal response test results show that the controller can not only accurately track periodic input signals but also maintain high stability and tracking accuracy when subjected to disturbances.

Overall, the experimental results show that the controller of the present invention performs as expected in both the step response test and the sinusoidal response test, thereby verifying that the system has excellent dynamic response characteristics and disturbance rejection capability. The analysis of the results from the embodiments of the present invention demonstrates that the controller possesses robustness and response characteristics that satisfy practical application requirements, providing reliable assurance for stability and accuracy in engineering practice.

The basic principles, main features, and advantages of the present invention have been shown and described above. Those skilled in the art should understand that the above embodiments do not limit the present invention in any way, and technical solutions obtained by equivalent substitution or equivalent transformation all fall within the protection scope of the present invention.

What is claimed is:

1. An active disturbance rejection control method for a linear electric-driven joint of a humanoid robot, comprising:
S1: establishing a dynamic model for a linear electric-driven joint system used in the humanoid robot;
S2: determining an extended state observer based on the dynamic model, estimating a state variable and an unknown disturbance of the system in real time, and dynamically compensating for the disturbance through the extended state observer;
S3: determining a nonlinear feedback control law based on states and estimated disturbance information observed by the extended state observer; and
S4: analyzing stability of the extended state observer and the nonlinear feedback control law, and adjusting parameters of the extended state observer and the nonlinear feedback control law based on analysis results;
in Step S1, the dynamic model for a linear electric-driven joint system used in the humanoid robot is:
M\ddot{q}+B\dot{q}+Kq=F,
wherein M is an equivalent mass of a driver, B is a damping coefficient, K is a stiffness coefficient, q is a joint position, and F is a control input;
in Step S1, the dynamic model is also converted to obtain a state-space model of the system; and
in Step S1, a method for converting the dynamic model to obtain the state-space model of the system specifically comprises:
defining the state variable:
x₁=q, x₂=\dot{q},
wherein a state vector is
$$x = [ \begin{matrix}{x}_{1} \\ {x}_{2}\end{matrix} ] = [ \begin{matrix}q \\ \dot{q}\end{matrix} ] ,$$
the dynamic model is converted into a state-space form:
\dot{x}₁=x₂,
$$\dot{{x}_{2}} = \frac{F - {Bx}_{2} - {Kx}_{1}}{M} ,$$
and finally a state-space model of the dynamic model of the system is obtained and has a state equation as follows:
$$\dot{x} = [ \begin{matrix}0 & 1 \\ - \frac{K}{M} & - \frac{B}{M}\end{matrix} ] x + [ \begin{matrix}0 \\ \frac{1}{M}\end{matrix} ] F .$$

2. The active disturbance rejection control method for a linear electric-driven joint of a humanoid robot according to claim 1, wherein
in Step S2, the system is affected by the unknown disturbance d(t), the unknown disturbance d(t) is regarded as a total disturbance and estimated by the extended state observer, and the total disturbance d(t) is:
$$d ( t ) = - \frac{K}{M} {x}_{1} - \frac{B}{M} {x}_{2} ;$$
the total disturbance d(t) and a system state are jointly estimated by extending a new state variable z, and the extended state observer is:
\dot{\hat{x}}₁=\hat{x}₂−β₁(y−\hat{x}₁);
$${\dot{\hat{x}}}_{2} = \frac{F}{M} + \hat{z} - {β}_{2} ( y - {\hat{x}}_{1} ) ;$$
ż=−β₃(y−\hat{x}₁);
wherein \hat{x} is an estimated system state, \hat{z} is an estimated total disturbance, y=x₁ is a system output, and β₁, β₂, and β₃ are gain parameters of the extended state observer.

3. The active disturbance rejection control method for a linear electric-driven joint of a humanoid robot according to claim 2, wherein
in Step S3, a nonlinear error feedback control law is used to generate the control input F, so that the system achieves a desired output; and the nonlinear error feedback control law is:
F=M(v−\hat{z});
wherein vis a virtual control variable used to generate a desired dynamic behavior:
v=−k₁(q−q_{ref})−k₂\dot{q};
wherein q_{ref} is a desired joint position, and k₁ and k₂ are control gain parameters.

4. The active disturbance rejection control method for a linear electric-driven joint of a humanoid robot according to claim 3, wherein
in Step S4, a Lyapunov function V(e) is constructed to analyze the stability of the extended state observer:
$$V ( e ) = \frac{1}{2} ( {e}_{1}^{2} + {e}_{2}^{2} + {e}_{z}^{2} ) ;$$
a derivative of the Lyapunov function is taken as follows:
\dot{V}(e)=e₁ė₁+e₂ė₂+e_{z}ė_{z};
based on the formula of the extended state observer in Step S2, an error equation is obtained; an error dynamic equation is substituted into the above formula to obtain:
$$\dot{V} ( e ) = - {β}_{1} {e}_{1}^{2} - \frac{B}{M} {e}_{2}^{2} + ( {β}_{2} - \frac{K}{M} ) {e}_{1} {e}_{2} - {β}_{3} {e}_{z}^{2} ;$$
and the parameters β₁, β₂, and β₃ are selected to enable \dot{V}(e)<0 to ensure asymptotic stability of the system.

5. The active disturbance rejection control method for a linear electric-driven joint of a humanoid robot according to claim 3, wherein
in Step S4, the nonlinear error feedback control law is analyzed, and is substituted into a system equation to obtain a closed-loop system:
\dot{x}₁=x₂;
\dot{x}₂=−k₁(x₁−q_{ref})−k₂x₂+d(t)−\hat{z};
a closed-loop system without disturbance is considered as:
$$[ \begin{matrix}{\dot{x}}_{1} \\ {\dot{x}}_{2}\end{matrix} ] = [ \begin{matrix}0 & 1 \\ - {k}_{1} & - {k}_{1}\end{matrix} ] [ \begin{matrix}{x}_{1} \\ {x}_{2}\end{matrix} ] ;$$
a characteristic equation is:
λ²+k₂λ+k₁=0,
and k₁ and k₂ are selected to ensure that an eigenvalue has a negative real part, thereby ensuring system stability.

6. The active disturbance rejection control method for a linear electric-driven joint of a humanoid robot according to claim 5, wherein
value ranges of k₁ and k₂ are: k₁>0, k₂>0, and
$${k}_{2}^{2} - 4 {k}_{1} < 0.$$
